(19) United States
(12) Patent Application Publication
(10) Pub. No.: US 2024/0320654 A1
(43) Pub. Date: Sep. 26, 2024

(54) COMPUTERIZED METHOD AND SYSTEM FOR DIGITAL PAYMENTS

(71) Applicant: CRUNCHFISH DIGITAL CASH AB, Malmo (SE)

(72) Inventors: Joachim SAMUELSSON, Helsingborg (SE); Paul CRONHOLM, Malmo (SE)

(21) Appl. No.: 18/714,757

(22) PCT Filed: Dec. 1, 2022
(86) PCT No.: PCT/SE2022/051132

§ 371 Date: May 30, 2024

(30) Foreign Application Priority Data
Dec. 1, 2021 (SE) 2151468-2
Dec. 14, 2021 (SE) 2151529-1
Jan. 28, 2022 (SE) 2250076-3

(51) Int. Cl. G06Q 20/36; G06Q 20/08

(52) U.S. Cl. CPC G06Q 20/36; G06Q 20/085

(57) ABSTRACT

A computerized method (600) of performing a digital payment involves maintaining (610), at a financial institution (PB1), a reservation of funds in a payer account (PA1) of a payer (P1), and maintaining (620), by a computerized digital wallet server function (DCWS), a digital wallet (DCW) having a balance corresponding to the reservation of funds in the payer account. The method further involves making (630), by a payer communication device (PD1) usable by the payer, a payment request (PR) for the digital payment at the digital wallet sewer function. The digital wallet sewer function registers (640) transaction data (TXD) that comprises an alias of the payer (PayerAlias), an alias of a payee (PayeeAlias), and a representation of a payment amount (Amount) which is deducted from the balance of the digital wallet. The digital wallet server function causes (650) a digital notification of the digital payment to a payee communication device (PD2) usable by the payee, storing (660) of the transaction data for later settlement; and subsequent initiation (670) of settlement of the digital payment based on the stored transaction data to cause release of funds from a balance of the payer account and addition of funds to a payee account (PA2) associated with the payee, wherein the deduction and addition of funds correspond to the payment amount.

### TECHNICAL FIELD

The present invention generally relates to the field of digital payments. More particularly, the present invention relates to technical improvements to achieve a versatile ecosystem for digital payments. Even more particularly, the present invention relates to a computerized method of performing a digital payment by a payer to a payee, either as a stand-alone digital payment service or as a complementary additional service layer to an existing digital payment system such as, for instance, an instant payment system. The present invention further relates to a digital payment system and to associated communication devices, server-based computing resources, computer program products and computer readable media, as well as a multi-layered digital payment system architecture.

### BACKGROUND

As everybody knows, there has been an overwhelming market penetration for communication devices such as smart phones, tablets and personal computers. Typically, such communication devices are enabled for wide-area network, WAN, communication (broadband RF-based or wired communication) with remote entities, for instance via cellular radio systems like 5G, UMTS or GSM, or via wireless local area network, WLAN, access to route IP traffic to and from such remote entities. In addition, communication devices are often enabled for short-range wireless data communication, such as Bluetooth, with other devices nearby. Such a nearby device may for instance be an accessory or peripheral device, like a wireless headset or wireless speakers.

Thanks to this ability, users of communication devices may enjoy a plethora of digital services that involve communication with cloud-based resources. A very popular type of such digital services is digital payments. Throughout this document, the term “digital payment” is to be construed broadly to embrace any kind of digital transfer of economic value in digital form on behalf of or between people of any types, roles etc.

The present inventors have identified some shortcomings of existing digital payment systems. For instance, digital payment systems are vulnerable to disruption and down-time as digital payment systems are reliant on several payment server functions, e.g. core banking systems, payment service providers, payment switches, that have to be fully operational in order for the digital payment to be processed.

A frequent situation is that a digital payment is part of an exchange of goods or services subject to a payment. The payer makes a digital payment to the payee, in exchange of which the payee is to hand over or deliver certain goods or perform certain services. From the payee's perspective, it is important to be able to rely on the solvency of the digital payment, i.e. that the payee can rely on the digital payment and trust the payer to the extent that the payee will be able to retrieve an actual monetary value from the received digital payment.

From the perspectives of both the payer and the payee, and considering the truly mobile nature of contemporary communication devices, it would be beneficial if the digital payments could be performed in various different situations of communication ability.

The present inventors have realized that contemporary digital payment solutions are subject to certain challenges in terms of availability in situations of service disruption, service congestion or even no momentary network access; load balancing; instant payment verification; service interoperability; security; service versatility; user convenience; and user privacy.

### SUMMARY

In line with the observations above, the present inventors have made valuable technical insights to solve or at least mitigate one or more of the challenges referred to in the previous section. These insights will be presented as inventive aspects below as well as in the detailed description section, the claims and the drawings. The list of inventive aspects is not to be seen as exhaustive but rather a summary of particularly beneficial inventive aspects.

A first inventive aspect is a computerized method of performing a digital payment by a payer to a payee. The method comprises maintaining, at a financial institution, a reservation of funds in a payer account, the payer account being associated with the payer. The method further comprises maintaining, by a computerized digital wallet server function, a digital wallet for the payer, the digital wallet having a balance corresponding to the reservation of funds in the payer account.

Additionally, the method comprises making, by a payer communication device usable by the payer, a payment request for the digital payment at the digital wallet server function.

Moreover, the method comprises the following activity by the digital wallet server function: Registering transaction data for the digital payment, the transaction data comprising an alias of the payer, an alias of the payee, and a representation of a payment amount, the payment amount being deducted from the balance of the digital wallet. Causing a digital notification of the digital payment to a payee communication device usable by the payee. Storing the transaction data for later settlement. Finally, subsequently initiating settlement of the digital payment based on the stored transaction data to cause release of the payment amount from the reservation of funds, deduction of funds from a balance of the payer account and addition of funds to a payee account associated with the payee, wherein the deduction and addition of funds correspond to the payment amount.

This computerized method will allow payees to receive and accept digital payments in an instant, convenient, versatile and trustworthy manner without requiring all payment server functions of a digital payment system to be operational. If the computerized method is implemented as a complement or additional computerized layer of an existing digital payment system that involves computerized core banking resources (such as server resources, storage resources and network resources), it may bring particular value to the existing digital payment system by offloading various payment-related functions of the computerized core banking resources, thereby mitigating or avoiding service congestion or bottleneck problems and offering an improvement in the load balancing of the computerized core banking resources. These advantages are applicable also to the other inventive aspects which are referred to further below.

Embodiments of the method according to the first inventive aspect are described in following sections of this document as well as in the attached drawings.

A second inventive aspect is a digital payment system which comprises a computerized digital wallet server function, and a payer communication device usable by a payer. The payer communication device is configured for making a payment request for a digital payment at the digital wallet server function.

The computerized digital wallet server function is configured for maintaining a digital wallet for the payer, the digital wallet having a balance corresponding to a reservation of funds in a payer account maintained at a financial institution, the payer account being associated with the payer.

The computerized digital wallet server function is further configured for registering transaction data for the digital payment, the transaction data comprising an alias of the payer, an alias of a payee, and a representation of a payment amount, the payment amount being deducted from the balance of the digital wallet.

The computerized digital wallet server function is moreover configured for causing a digital notification of the digital payment to a payee communication device usable by the payee and for storing the transaction data for later settlement.

The computerized digital wallet server function is also configured for subsequently initiating settlement of the digital payment based on the stored transaction data to cause release of the payment amount from the reservation of funds, deduction of funds from a balance of the payer account and addition of funds to a payee account associated with the payee, wherein the deduction and addition of funds correspond to the payment amount.

The digital payment system according to the second inventive aspect may be further configured for performing the functionality of the method according to the first inventive aspect, including any of its embodiments as described in this document.

A third inventive aspect is a server-based computing resource configured to perform the functionality of the computerized digital wallet server function in the method or system as disclosed for the first or second inventive aspect in this document.

A fourth inventive aspect is a communication device configured to perform the functionality of the payer communication device in the method or system as disclosed for the first or second inventive aspect in this document. The communication device may, for instance, be one of the following: a mobile communication device; a mobile phone; a smart phone; a tablet computer; a personal digital assistant; a portable computer; smart glasses; a smart wearable; a smart watch; a smart bracelet; a smart card; and a smart chip.

A fifth inventive aspect is a communication device configured to perform the functionality of the payee communication device in the method or system as disclosed for the first or second inventive aspect in this document. The communication device may, for instance, be one of the following: a mobile communication device; a mobile phone; a smart phone; a tablet computer; a personal digital assistant; a portable computer; smart glasses; a smart watch; a smart card; a smart bracelet; a smart wearable; a payment terminal, a service terminal; a point-of-sales terminal; a checkout counter; a delivery pickup point; a vending machine; a ticket machine; a dispensing machine; and an access control system.

A sixth inventive aspect is a computer program product comprising computer code for performing the functionality of the computerized digital wallet server function in the method or system according to the first or second inventive aspect when the computer program code is executed by a processing device.

A seventh inventive aspect is a computer program product comprising computer code for performing the functionality of the payer communication device in the method or system according to the first or second inventive aspect when the computer program code is executed by a processing device.

An eighth inventive aspect is a computer program product comprising computer code for performing the functionality of the payee communication device in the method or system according to the first or second inventive aspect when the computer program code is executed by a processing device.

A ninth inventive aspect is a computer readable medium having stored thereon a computer program comprising computer program code for performing the functionality of the computerized digital wallet server function in the method or system according to the first or second inventive aspect when the computer program code is executed by a processing device.

A tenth inventive aspect is a computer readable medium having stored thereon a computer program comprising computer program code for performing the functionality of the payer communication device in the method or system according to the first or second inventive aspect when the computer program code is executed by a processing device.

An eleventh inventive aspect is a computer readable medium having stored thereon a computer program comprising computer program code for performing the functionality of the payee communication device in the method or system according to the first or second inventive aspect when the computer program code is executed by a processing device.

A twelfth inventive aspect is a multi-layered digital payment system architecture that comprises a core banking system layer that pertains to a financial institution and includes computerized core banking resources, the computerized core banking resources maintaining an account balance for an account owned or controlled by a bank client. The architecture further comprises a first additional layer allowing the bank client to make online digital payments from a digital wallet having a balance which has been reserved from the account balance in the core banking system layer. In advantageous embodiments, the architecture further comprises second and third additional layers allowing offline digital payments.

As used in this document, the term “short-range data communication” includes any form of proximity-based device-to-device communication, unidirectional or bidirectional. This includes radio-based short-range wireless data communication such as, for instance, Bluetooth, BLE (Bluetooth Low Energy), RFID, WLAN, WiFi, mesh communication or LTE Direct, without limitation. It also includes non-radio-based short-range wireless data communication such as, for instance, magnetic communication (such as NFC), audio communication, ultrasound communication, or optical communication (such as QR, barcode, IrDA).

As used in this document, the term “wide area network communication” (abbreviated as “WAN communication”) includes any form of data network communication with a party which may be remote (e.g. cloud-based), including cellular radio communication like W-CDMA, GSM, UTRAN, HSPA, LTE, LTE Advanced or 5G, possibly communicated as TCP/IP traffic, or via a WLAN (WiFi) access point, without limitation. Moreover, the terms “long-range data communication” and “broadband data communication” are considered as synonyms of “wide-area network communication”.

Expressions like “[entity] is configured for . . . [performing activity]” or “[entity] is configured to . . . [perform activity]” will include typical cases where a computerized entity (having one or more controllers, processing units, programmable circuitry, etc.) executes software or firmware installed in the computerized entity, wherein the execution occurs in order to perform the activity in question.

Other aspects, objectives, features and advantages of the inventive aspects will appear from the following detailed disclosure as well as from the claims and the drawings. Generally, all terms used herein are to be interpreted according to their ordinary meaning in the technical field, unless explicitly defined otherwise herein.

All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

FIG. 1A is a schematic illustration of a conventional system for digital payments.

FIG. 1B is a schematic illustration of how inventive functionality can be added to improve the conventional system in FIG. 1A.

FIGS. 2A-2D are schematic illustrations of a digital payment system and a computerized method according to inventive aspects in different embodiments thereof.

FIG. 3 is a schematic block diagram of a communication device that may implement a payer communication device suitable for use in the digital payment system and computerized method.

FIG. 4 is a schematic block diagram of a communication device that may implement a payee communication device suitable for use in the digital payment system and computerized method.

FIG. 5A is a schematic illustration of a computer-readable medium in one exemplary embodiment, capable of storing a computer program product.

FIG. 5B illustrates a multi-layered digital payment system architecture according to embodiments of the invention, being an add-on to an existing core banking system.

FIG. 6 is a schematic flowchart diagram of a computerized method of performing a digital payment by a payer to a payee according to the present invention.

FIG. 7 is a sequence and signal diagram illustrating certain top-up activities in embodiments of the present invention.

FIG. 8 is a sequence and signal diagram illustrating certain payment activities in embodiments of the present invention.

FIG. 9 is a sequence and signal diagram illustrating certain settlement activities in embodiments of the present invention.

FIG. 10 is a sequence and signal diagram illustrating certain offline_payment activities in embodiments of the present invention.

FIG. 11 is a sequence and signal diagram illustrating certain payment confirmation activities in embodiments of the present invention.

### DETAILED DESCRIPTION

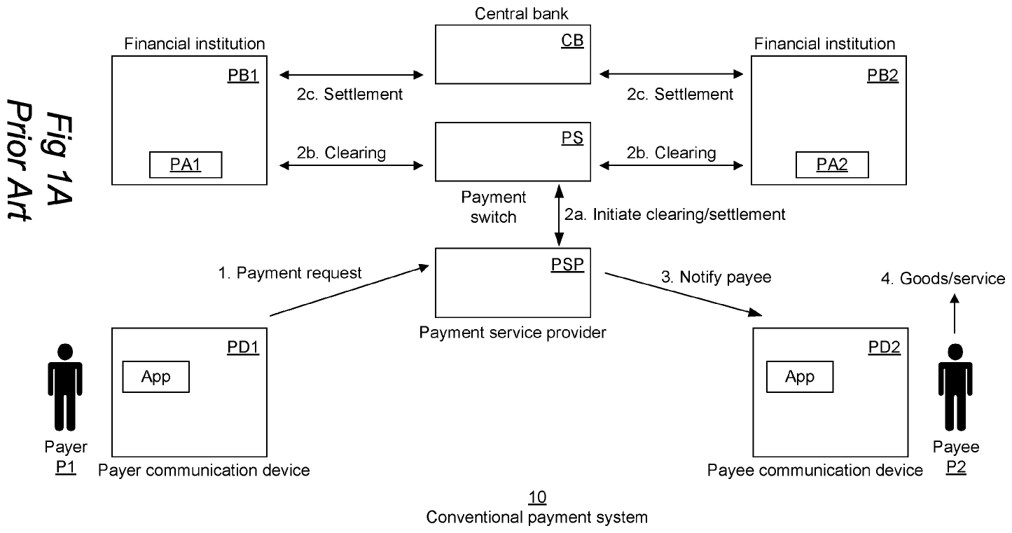

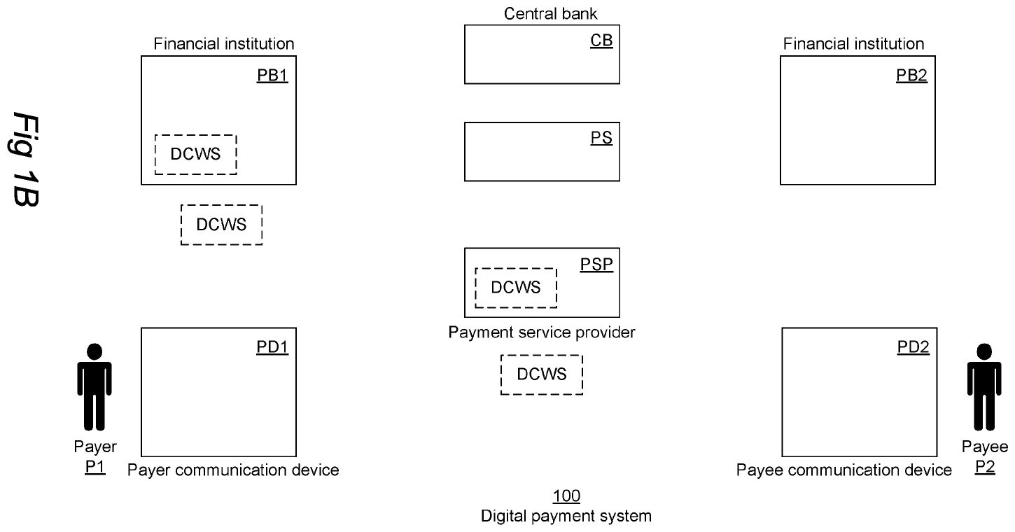

A conventional system 10 for digital payments is shown in FIG. 1A. A payment service provider PSP is adapted to provide payment services to users. A payer P1 makes a payment request 1 for a digital payment to a payee P2 by using a payer communication device PD1. The payment service provider PSP initiates settlement at 2a by invoking a payment switch PS. Clearing 2b and settlement 2c of the digital payment will transfer the payment amount from a payer account PA1 at a first financial institution PB1 to a payee account PA2 at a second financial institution PB2. The first and second financial institutions PB1, PB2 may for instance be banks. A central bank CB is involved in the actual settlement 2c. If the digital payment is an instant payment, clearing 2b and settlement 2c occur essentially instantly without any substantial delay between the two. If the digital payment is a card payment, like an EMV payment, settlement 2c may be performed long after clearing 2b. The payee P2 using a payee communication device PD2 can be notified 3 of the digital payment thus performed once clearing and settlement, or at least clearing, has been duly completed. In turn, this allows the payee P2 at 4 to provide a goods or perform a service which is the subject of the digital payment.

Please note, however, that such notification 3 requires the whole system 10 to be operational at the time of performing the digital payment. If any of the entities in FIG. 1A is momentarily inoperative or inaccessible to the other entities of the system 10, the digital payment will be delayed, and so will the notification 3 and provision/performance 4 of the goods or service at the payee P2.

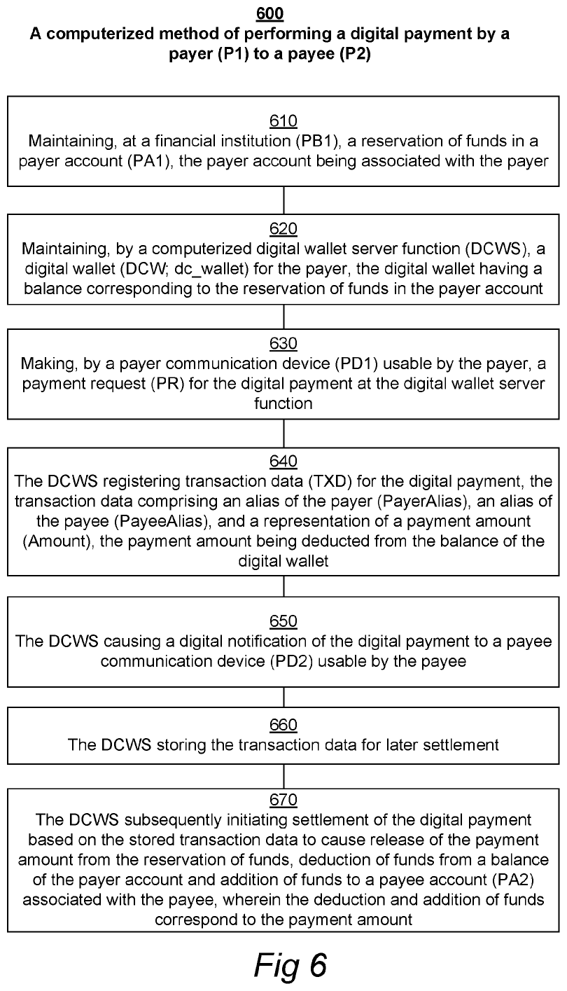

FIG. 1B is a schematic illustration of how inventive functionality can be added to improve the conventional system in FIG. 1A, thus rendering an improved digital payment system 100. The inventive functionality involves a computerized digital wallet server function DCWS, which is described in more detail in the remaining drawings. The improved digital payment system 100 will allow payees to receive and accept digital payments in an instant, convenient and trustworthy manner without requiring all payment server functions of a conventional digital payment system to be operational. Accordingly, a corresponding computerized method 600 of performing a digital payment by the payer P1 to the payee P2 is shown at steps 610-670 of FIG. 6.

As can be seen in FIG. 1B, the digital wallet server function DCWS can be implemented in various difference ways in the digital payment system 100. For instance, it may be implemented in, by or as a server-based computing resource at the first financial institution PB1 or as a separate server-based computing resource connected to, interacting with or controlled by the first financial institution PB1 (a cloud computing resource being a typical example of such a separate server-based computing resource). In embodiments of the invention, the digital wallet server function DCWS and the computerized method in which is it operated (see FIG. 6) may be seen as a complement or additional computerized layer of an existing digital payment system that involves the computerized core banking resources (such as server resources, storage resources and network resources) of the first financial institution PB1. The computerized digital wallet server function DCWS may even be hosted by the first financial institution PB1. In this regard, the digital wallet server function DCWS and the computerized method in which is it operated may offload various payment-related functions of the computerized core banking resources, thereby mitigating or avoiding service congestion or bottleneck problems and offering an improvement in the load balancing of the computerized core banking resources.

Alternatively, the digital wallet server function DCWS may be implemented in, by or as a server-based computing resource at the payment service provider PSP or as a separate server-based computing resource (e.g. cloud computing resource) connected to, interacting with or controlled by the payment service provider PSP. Other implementation alternatives are also conceivable.

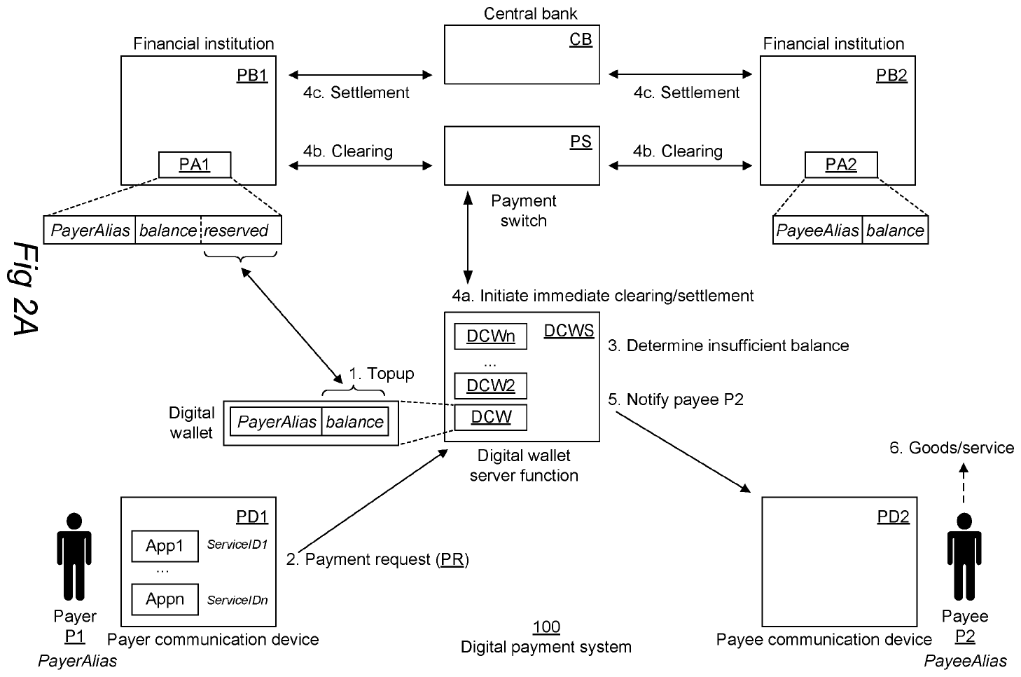

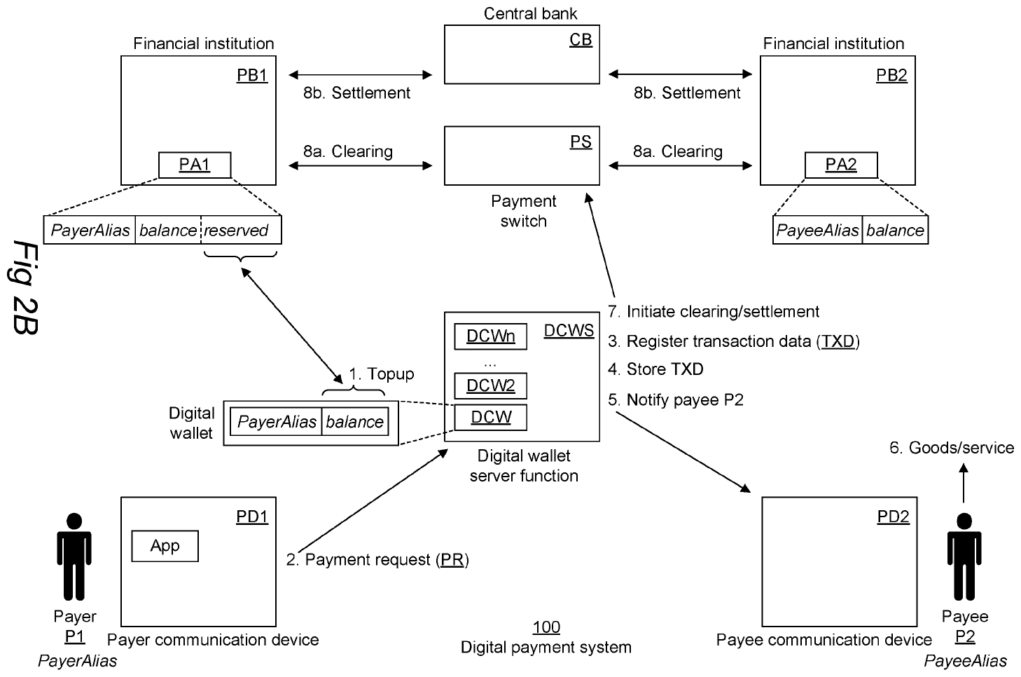

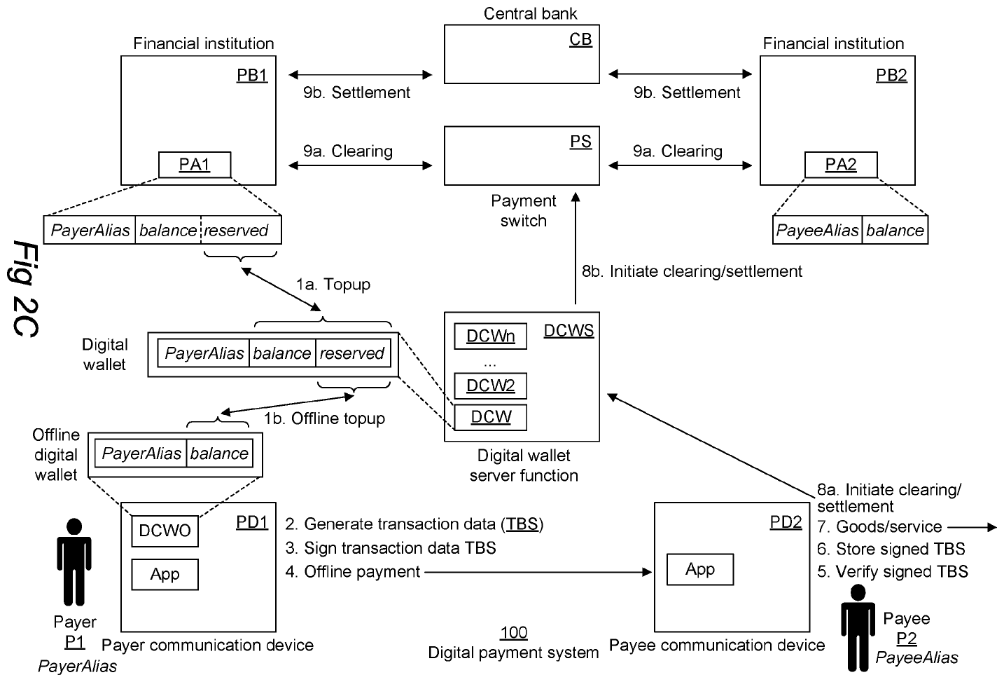

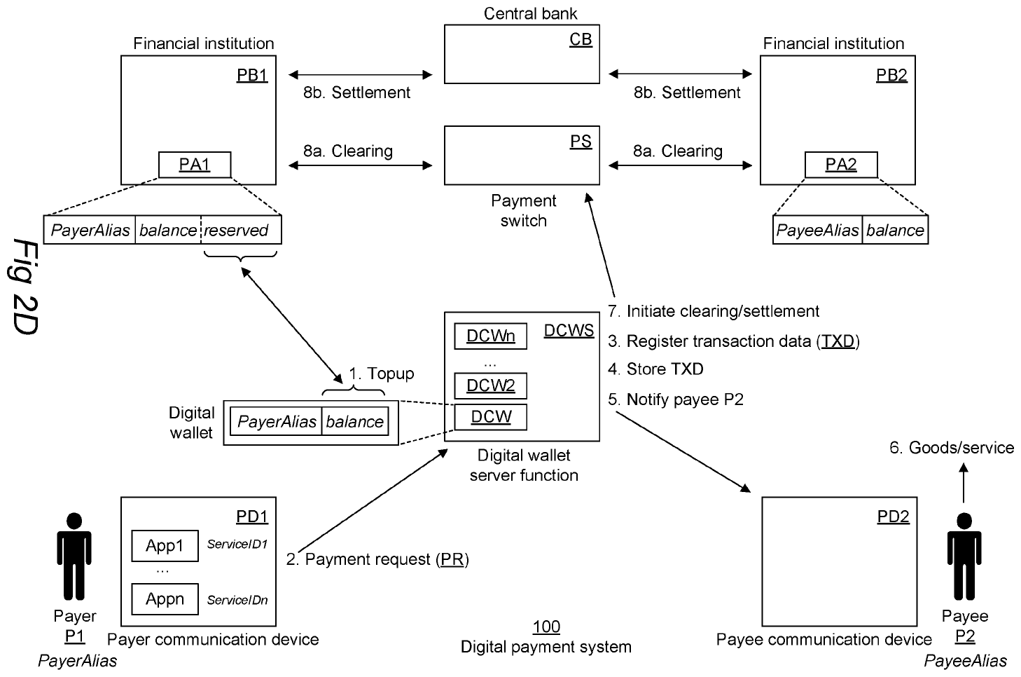

The digital payment system 100 with the computerized digital wallet server function DCWS will now be described in more detail with reference to the remaining drawings. The digital payment system 100 comprises the computerized digital wallet server function DCWS and the payer communication device PD1 which is usable by the payer P1. The payer communication device PD1 is configured for making a payment request PR for a digital payment at the digital wallet server function DCWS, see step 2 in FIGS. 2A-B.

In preferred embodiments of the digital system 100, the digital payment can be handled in as many as three different ways, which are illustrated in FIG. 2A (immediate clearing/settlement), FIG. 2B (online payment using a digital wallet DCW managed by the digital wallet server function DCWS), and FIG. 2C (offline_payment using an offline digital wallet DCWO managed by the payer communication device PD1. This approach has considerable advantages with respect to one or more of the challenges referred to in the Summary section, i.e. handling situations of service disruption, service congestion or even no momentary network access; load balancing; instant payment verification; service interoperability; security; service versatility; user convenience; and user privacy.

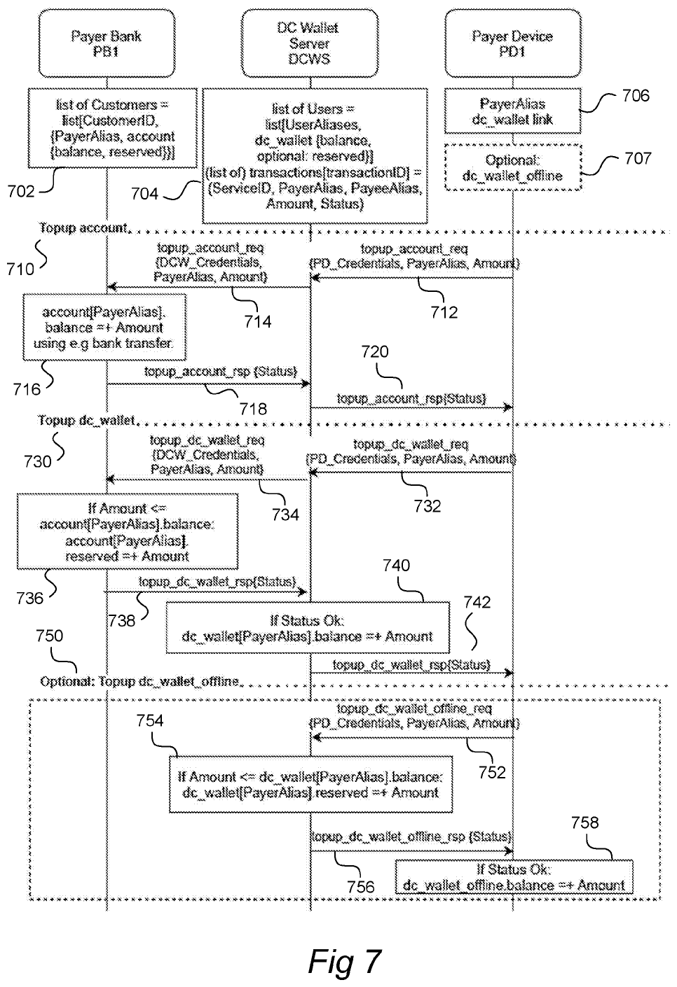

The computerized digital wallet server function DCWS is configured for maintaining a digital wallet DCW (referred to as dc_wallet in FIGS. 7-11) for the payer P1. Also see step 620 of the computerized method in FIG. 6. The digital wallet DCW has a balance corresponding to a reservation of funds in the payer account PA1 associated with the payer P1 and maintained at the financial institution PB1 (cf. step 610 in FIG. 6). The reservation of funds may, for instance, be made with respect to a positive account balance or, alternatively, a line of credit of the payer account PA1. This has been done at a topup procedure 1/1a in FIGS. 2A-C. One embodiment of the topup procedure is shown in FIG. 7.

In response to the payment request PR made by the payer communication device PD1 (cf step 630 in FIG. 6), the computerized digital wallet server function DCWS is further configured for registering transaction data TXD for the digital payment, causing a digital notification of the digital payment to the payee communication device PD2 usable by the payee, and storing the transaction data for later settlement. This can be seen at steps 3-5 in FIGS. 2B and 2D, as well as in steps 640-660 in FIG. 6. The transaction data comprises an alias of the payer (PayerAlias), an alias of a payee (PayeeAlias), and a representation of a payment amount (Amount). The representation may, for instance, be a numerical value of the payment amount, possibly together with an indication of a monetary currency. Alternatively, representation may be tokenized or another kind of cryptographic information. The payment amount is deducted from the balance of the digital wallet. Details of this functionality in one embodiment can be seen in FIGS. 8 and 11.

The computerized digital wallet server function DCWS is moreover configured for subsequently initiating (at step 7 in FIGS. 2B and 2D, and step 670 in FIG. 6) settlement of the digital payment based on the stored transaction data to cause release of the payment amount from the reservation of funds, deduction of funds from the balance of the payer account PA1 and addition of funds to the payee account PA2 associated with the payee, wherein the deduction and addition of funds correspond to the payment amount. For details of one embodiment, please see FIG. 9. In some embodiments, the deduction and the addition are equal to the payment amount, i.e., the payment amount Amount is subtracted from the balance of the payer account PA1 and is added to the balance of the payee account PA2. In some embodiments, a fee may be charged to the payer account account PA1 and/or payee account account PA2, wherein the deduction and/or addition may not be exactly identical to the payment amount Amount. In some embodiments, there may be a currency conversion at the payer side or the payee side.

The digital wallet server function DCWS may do the initiation in step 7 of the settlement of the digital payment by communicating the stored transaction data TXD to the computerized payment switch functionality PS. The payment switch functionality PS maintains cross-reference data (also see mapping in FIGS. 8, 9 and 11) that links payer aliases and payee aliases of payers and payees to user accounts at financial institutions PB1, PB2 or payment service providers (cf. PSP in FIG. 1). The payment switch functionality PS uses the communicated transaction data TXD and the cross-reference data to cause settlement of the digital payment. Clearing and settlement then take place at steps 8a and 8b in essentially the same way as in the conventional payment system 10 in FIG. 1A. Hence, the disclosed system 100 can advantageously be seen as at least a second layer added to an existing payment system (such as the payment system 10 in FIG. 1A), therefore making it considerably more versatile. In other embodiments, however, the disclosed system 100 may be a self-embodied full system for digital payments, not built as an additional layer of an existing system.

Importantly, thanks to the provision of the digital wallet server function DCWS, the payment and the settlement are divided. This allows for an early or instant notification to the payee at step 5 in FIGS. 2B and 2D that the payment amount has been logically transferred from the payer P1, even though the digital payment has not yet been settled. As a result, upon being instantly notified of the digital payment by the digital notification in step 5, the payee communication device PD2 may provide a goods or perform a service associated with the digital payment, as seen at 6, or enable the payee P2 to do so. The early or instant payee notification thus gives trust to release goods or perform a service.

With particular reference to FIG. 2D, payment service interoperability may be provided as follows in embodiments of the invention. The payer communication device PD1 is enabled for a plurality of payment services, each payment service having a respective payment service provider (cf. PSP in FIG. 1). The payer communication device PD1 includes in the payment request PR an indication ServiceID of a selected payment service among said plurality of payment services. The digital wallet server function DCWS includes the indication ServiceID of the selected payment service in the transaction data TXD for the digital payment. The payment switch function PS uses the indication of the selected payment service to communicate with the payment service provider of the selected payment service. For details of some embodiments, please see FIGS. 8-11.

Advantageously, with particular reference to FIG. 2A, the digital wallet server function DCWS may initially check in step 3 whether the payment amount of the payment request PR for the digital payment exceeds the balance of the digital wallet DCW; dc_wallet for the payer PL. If so, the digital wallet server function DCWS may refrain from performing the steps in FIG. 2B of registering 3, storing 4, causing 5 a digital notification, and subsequently initiating settlement 7, and instead immediately initiate settlement 4a of the digital payment based the alias of the payer PayerAlias, the alias of the payee PayeeAlias and the representation of a payment amount Amount to cause deduction of funds from the balance of the payer account PA1 and addition of funds to the payee account PA2, wherein the deduction and addition of funds correspond to the payment amount. Notification to the payee P2 in step 5 may then be done in the conventional way, i.e. after clearing/settlement.

In some embodiments, the digital payment may be split into two parts. This may be beneficial when the payment amount that the payer P1 wishes to pay is not fully covered by the balance of the digital wallet DCW. In such a situation, it may be convenient for the payer P1 to spend whatever balance that he or she has available in the digital wallet DCW, and have the rest of the desired payment amount being withdrawn directly from the payer account PA1 maintained at the financial institution PB1. In effect, this means that the digital payment will be handled in a way which is a combination of the approaches taken in FIGS. 2B and 2A, as is explained below.

Accordingly, upon having received the payment request PR at step 2 in FIG. 2A, the digital wallet server function DCWS may be configured in step 3 to initially determine that the payment amount of the payment request PR for the digital payment exceeds the balance of the digital wallet DCW for the payer P1, and accordingly split the digital payment in two parts as follows.

The digital wallet server function DCWS will perform a first part of the digital payment by performing the steps 3-5 and 7 in FIG. 2B, however in a reduced first payment amount which does not exceed the balance of the digital wallet DCW for the payer P1. Typically, the reduced first payment amount will be equal to the balance of the digital wallet DCW. However, it is also possible to let the payer P1 select freely (within the boundaries of the balances of the digital wallet DCW and the payer account PA1 at the financial institution PB1) how to dispose of the digital payment.

Furthermore, the digital wallet server function DCWS will perform a second part of the digital payment by performing steps 4a and 5 in FIG. 2A, however in a second payment amount being the difference between the original payment amount desired by the payer P1 and the reduced first payment amount. The second part of the digital payment will hence involve initiating immediate settlement of the digital payment based on the alias of the payer PayerAias, the alias of the payee PayeeAlias and a representation of the second payment amount to cause deduction of funds from the balance of the payer account PA1 and addition of funds to the payee account PA2, wherein the deduction and addition of funds correspond to the second payment amount.

The temporal relation between the first and second parts of the digital payment may be such that both parts are performed essentially in parallel, i.e. the digital wallet server function DCWS will act to perform both of them independently of each other. In some embodiments, however, the first and second parts of the digital payment may be performed in sequence, such that the second part of the digital payment is performed only once the first part has been performed successfully, or such that first part of the digital payment is performed only once the second part has been performed successfully. Executing the first and second parts (or second and first parts) of the digital payment in sequence with an intermediate check that one of the parts has been successfully completed before the other one is performed may be beneficial, since it may avoid problems with having to reverse one of the part if the other part did not succeed.

With particular reference to FIG. 2C, offline digital payments may be provided for as follows. The payer communication device PD1 may maintain an offline digital wallet DCWO; dc_wallet_offline for the payer P1. The offline digital wallet has a balance corresponding to a reservation of funds in the digital wallet DCW; dc_wallet maintained for the payer P1 by the computerized digital wallet server function DCWS. See topup procedure at step 1b in FIG. 2C, and also FIG. 7. An offline digital payment may be performed by the payer communication device PD1 generating in step 2 transaction data TBS for the offline digital payment, the transaction data comprising an alias of the payer PayerAlias, an alias of the payee PayeeAlias, and a representation of a payment amount Amount, the payment amount being deducted from the balance of the offline digital wallet DCWO.

The payer communication device PD1 will sign in step 3 the transaction data TBS for the offline digital payment, and communicate in step 4 the signed transaction data to the payee communication device PD2 using short-range data communication.

The payee communication device PD2 may receive the signed transaction data TBS from the payer communication device PD1, and verify in step 5 the signed transaction data TBS.

Upon successful verification, the payee communication device PD2 may store in step 6 the signed transaction data TBS and initiate in step 8a settlement of the offline digital payment based on the stored signed transaction data TBS to cause release of the payment amount from the reservation of funds in the digital wallet DCW, deduction of funds from the balance of the payer account and addition of funds to the payee account, wherein the deduction and addition of funds correspond to the payment amount.

Upon successful verification of the signed transaction data in step 5, the payee communication device PD2 may provide a goods or perform a service associated with the digital payment, or enable the payee P2 to do so. See step 7 in FIG. 2C.

Advantageously, the payer communication device PD1 signs the transaction data TBS for the offline digital payment by means of a private cryptographic key dcwallet_wallet_offline_priv_key kept secure by the payer communication device PD1. The signed transaction data TBS may be verified by means of a certified public cryptographic key (for instance contained in a digital certificate dcwallet_wallet_offline_cert) corresponding to the private cryptographic key.

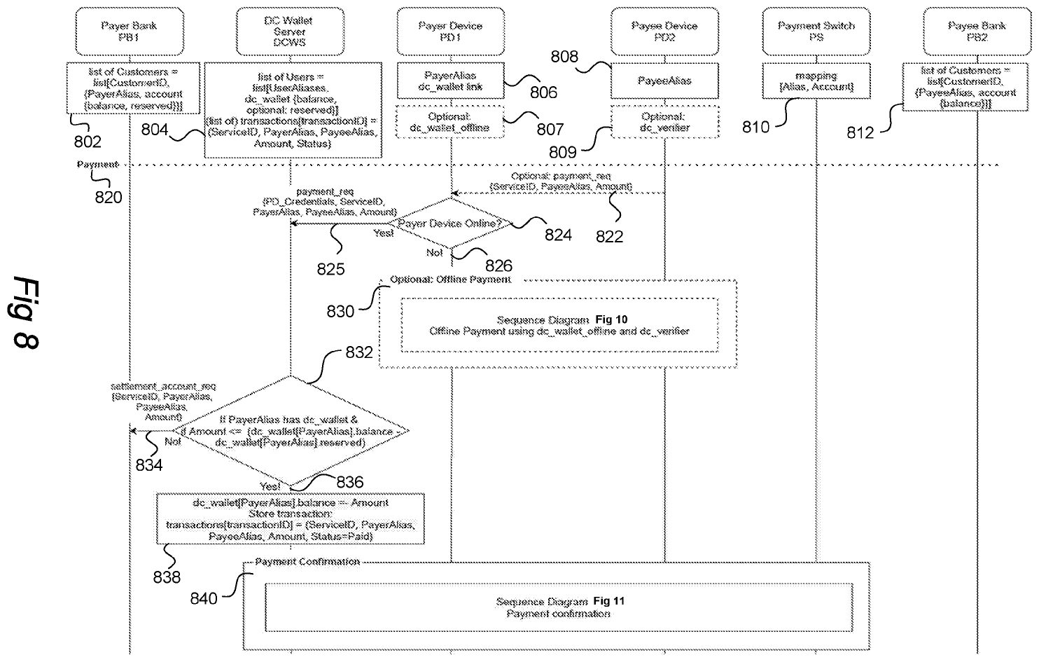

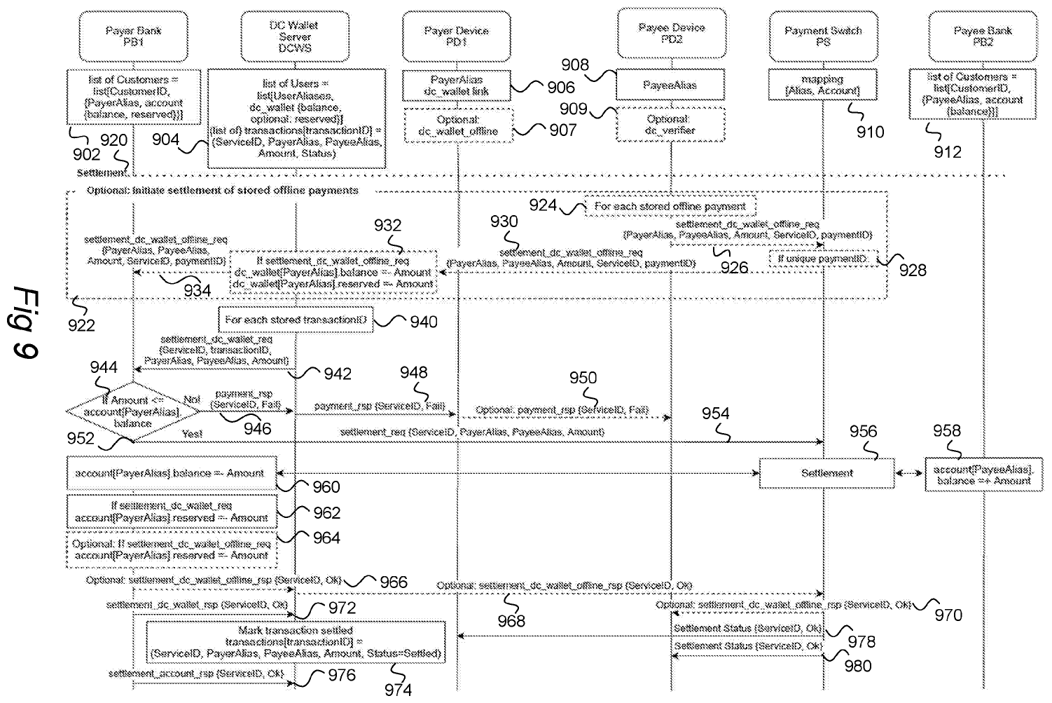

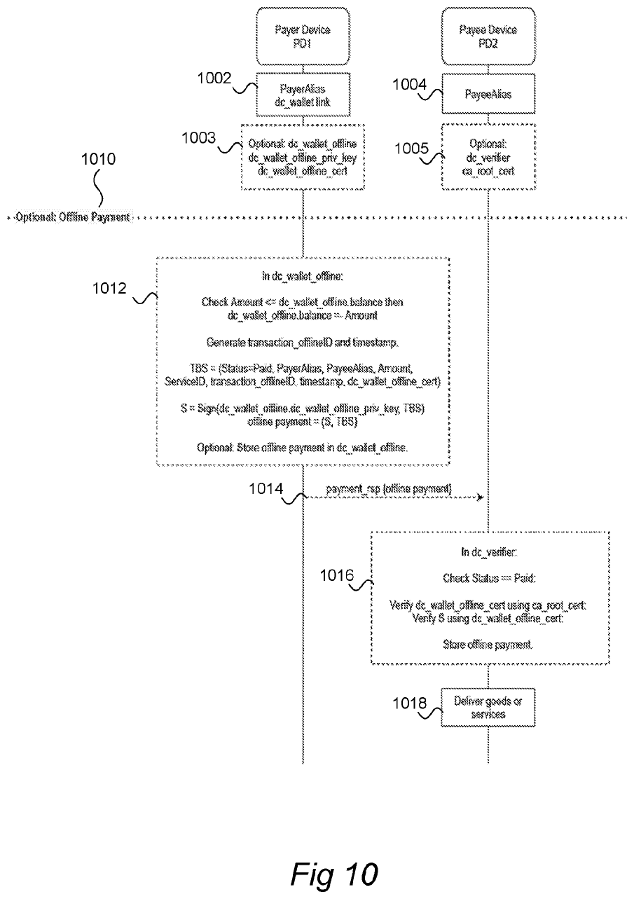

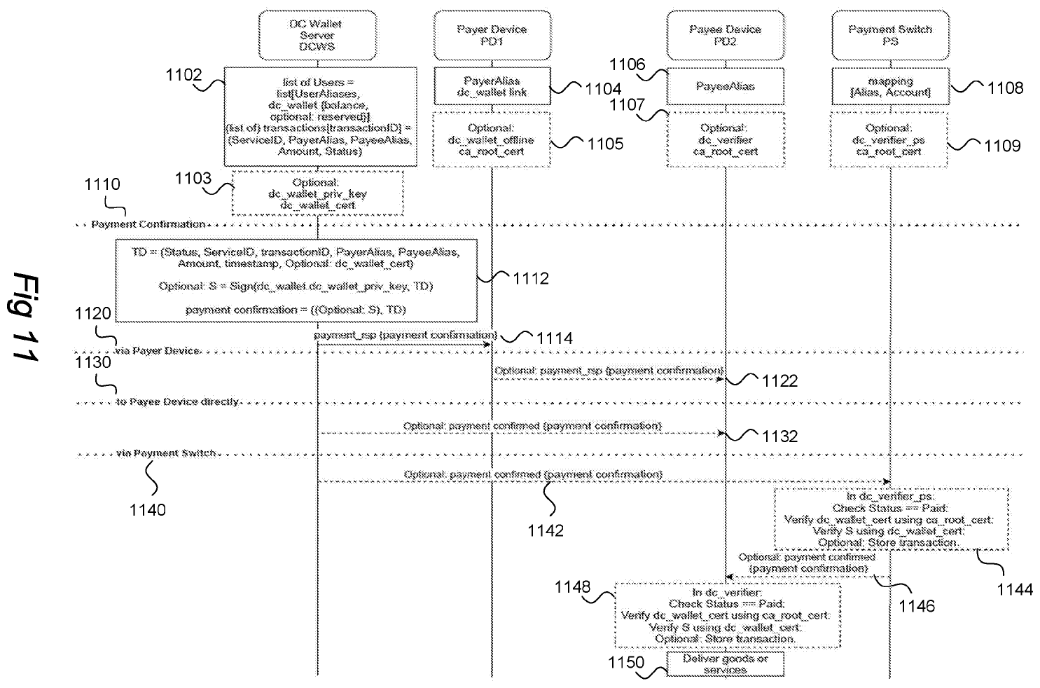

An embodiment for offline digital payments is disclosed in FIG. 10.

In a further refined embodiment for offline digital payments, an additional layer can be added to the digital payment system 100 in the form of a smart card, smart chip or similar small device which can be topped up by transferring funds from the balance of the offline digital wallet DCWO of the payer communication device PD1 (i.e., quite similar to the way in which the offline digital wallet DCWO of the payer communication device PD1 was topped up by making a reservation at the digital wallet DCW managed by the digital wallet server function DCWS). Once topped up, the smart card, smart chip or similar small device can be used for making an offline digital payment in much the same way as has been described above for the offline digital payment made from the offline digital wallet DCWO of the payer communication device PD1.

One example of suitable technology is disclosed in applicant's Swedish patent application 2150109-3, filed on 29 Jan. 2021. In brief, this application discloses a digital cash transfer system that comprises a mobile communication device having a local digital wallet and configured for enabling a user of the mobile communication device to make digital payments from the local digital wallet by wide area network data communication or short-range wireless data communication. The digital cash transfer system further comprises a smart card having secure electronic circuitry accommodating a cash deposit and configured for enabling a user of the smart card to make digital payments from the cash deposit at point of sales terminals. The mobile communication device and the smart card are configured to establish a local point-to-point communication link directly between the mobile communication device and the smart card upon being in proximity of each other; communicate cash transfer data over the local point-to-point communication link, the cash transfer data defining a local transfer of a monetary amount from one of the mobile communication device and the smart card, being a cash sender, to the other of the mobile communication device and the smart card, being a cash receiver; and update a balance of the local digital wallet as well as a balance of the cash deposit to reflect the local transfer of the monetary amount, such that the balance of the cash sender is reduced while the balance of the cash receiver is increased.

The contents of this Swedish patent application 2150109-3, or any application that claims priority from it, is incorporated herein by reference.

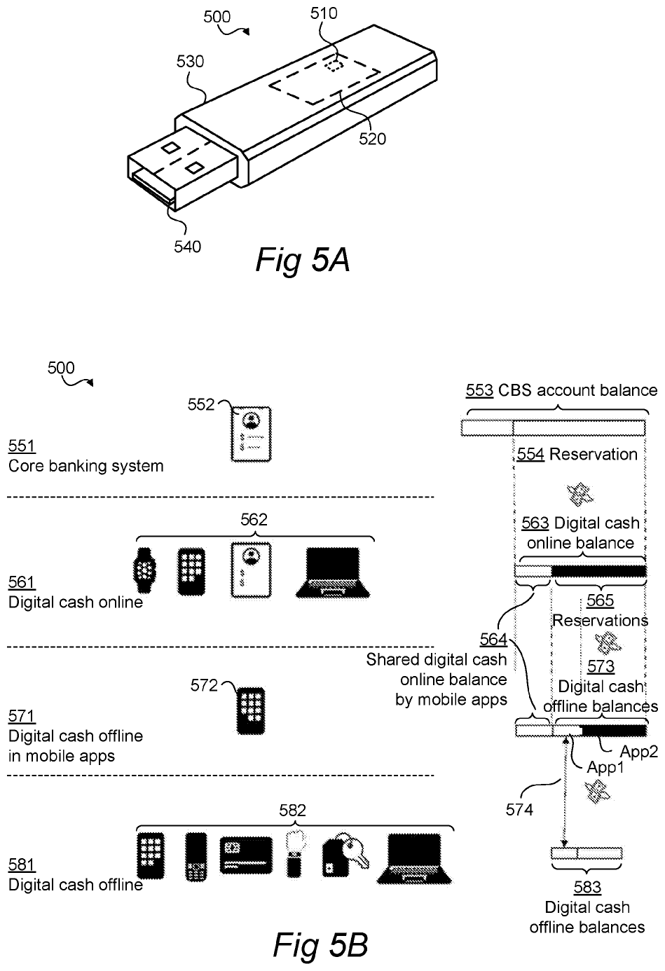

As a summary of what has been described above, FIG. 5B illustrates a multi-layered digital payment system architecture, or layout, offered by embodiments of the present invention as an add-on to an existing core banking system layer 551. The multi-layered digital payment system architecture comprises three additional layers which are seen at 561, 571 and 581 in FIG. 5B.

The core banking system layer 551 pertains to the financial institution PB1 and includes various computerized core banking resources, collectively indicated at 552 in FIG. 5B. The computerized core banking resources 552 maintains an account balance 553 for each account owned or controlled by a bank client. For the payer P1, this means the balance of the aforementioned payer account PA1. A certain part of the account balance 553 can be reserved 554 for use as a digital cash online balance 563.

The first additional layer 561 is a digital cash online layer which allows users of computerized devices 562 to make digital payments in the manner described above for FIG. 2B, i.e. by using the digital cash online balance 563 which has been reserved from the account balance 553 in the core banking system layer 551. Taking the aforementioned payer P1 using the payer communication device PD1 as an example, this will mean using the balance of P1's digital wallet DCW for the digital payment, as previously described. As can be seen at 564, the available digital cash online balance 563 may be shared between different payment service applications run by the user's computerized device, cf. the different applications App1-Appn for various payment services having different service identifiers ServiceID1-ServiceDn in FIG. 2D.

As seen at 565, some (or all) of the available digital cash online balance 563 may be reserved for use as one or more digital cash offline balances 573, potentially one for each payment service application. See App] and App 2 in FIG. 5B. Such digital cash offline balances 573 pertain to the second additional layer 571 which, thus, is a digital cash offline layer for mobile applications (application programs for mobile communication devices). The digital cash offline layer 571 allows users of mobile communication devices 572 (such as smart phones or tablet computers) to make digital payments in the manner described above for FIG. 2C, i.e. by using a digital cash offline balance 573 which has been reserved from the digital cash online balance 563 in the digital cash online layer 561. For payer P1 using the payer communication device PD1, this will mean using the balance of his or her offline digital wallet DCWO for the digital payment, as previously described with reference to FIG. 2C.

As can be seen at 574, an available digital cash offline balance 573 may be transferred partly (or fully) between the user's mobile communication device 572 and a smart card, smart chip or similar small device 582 by way of short-range data communication, as previously mentioned. The smart card, smart chip or similar small device 582 may be a separate physical (stand-alone) device, or coupled to, included in or integrated with a mobile communication device or other computerized device, as can be seen from the example devices shown at 582 in FIG. 5B. The smart card, smart chip or similar small device 582 will thus have a digital cash offline balance 583 which can be used for digital payments. The digital cash offline balance 583 pertains to the third additional layer 581 which, thus, is an extra digital cash offline layer, particularly suited for use with devices which are not enabled for mobile applications. In this way, even those kind of devices are enabled to make offline digital payments.

The transfer 574 between the user's mobile communication device 572 and the smart card, smart chip or similar small device 582 will be notified to the payment switch PS or another entity in the digital payment system 100. If the device 572 is online when the transfer is made, the notification may be made instantly. On the other hand, if the device 572 is offline when the transfer is made, the notification will be made when the device 572 regains online access. In such a case, there might be situations when an offline digital payment made from the smart card, smart chip or similar small device 582 using a transfer from the device 572 will reach the settlement stage in the digital payment system 100 already before notification of the transfer by the device 572. In view of this, a credit limit may be set for the smart card, smart chip or similar small device 582 so that it is only allowed to perform offline digital payments in certain smaller amounts; this will allow settlement of such an offline digital payment on a credit basis.

Hence, a payment sending device (for instance a smart card) can make an offline digital payment by acting in the corresponding way as the payer communication device PD1 did in steps 2-4 as described above for FIG. 2C. A payment receiving device (for instance a point-of-sales terminal) can receive, verify and store the offline digital payment, and subsequently initiate settlement (clearing), by acting much like the payee communication device PD2 did in steps 5, 6 and 8a as described above for FIG. 2C. The payment sending device may be operated by the same user as the mobile communication device 572 (e.g. payer P1), or by another user. This opens up for the possibility for a parent to transfer a small amount of digital value that a child can use for digital payments, without having access to a smartphone, etc.

In summary, this means that an embodiment of the computerized method as described in this document will involve transferring some or all of the balance of the offline digital wallet DCWO from the payer communication device PD1 to a payment sending device 582 by short-range data communication. The payment sending device 582 will use the transferred balance to make an offline digital payment in a payment amount covered by the transferred balance to a payment receiving device by performing the steps of the payer communication device PD1 as previously described for FIG. 2C. The payment receiving device will receive and handle the offline digital payment by performing the steps of the payee communication device PD2 as previously described for FIG. 2C.

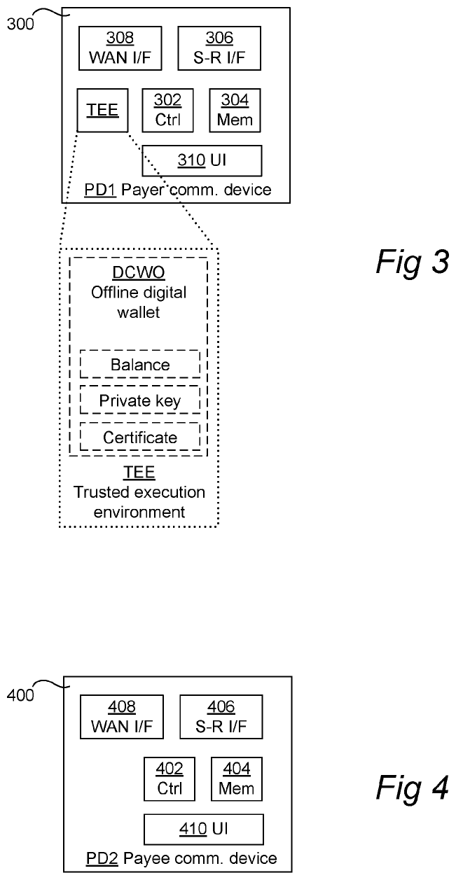

Reference is now being made to FIG. 3 and the communication device 300 illustrated therein. The communication device 300 may implement a payer communication device, like the aforementioned PD1, suitable for use in the digital payment system 100 and computerized method 600. To this end, the communication device 300 comprises a processing device 302, local storage including a memory 304, a short-range data communication interface 306, a wide area network communication interface 308 and a user interface 310.

The processing device 302 acts as a controller of the communication device 300 and may be implemented in any known controller technology, including but not limited to microcontroller, processor (e.g. PLC, CPU, DSP), FPGA, ASIC or any other suitable digital and/or analog circuitry capable of performing the intended functionality.

The memory 304 may be implemented in any known memory technology, including but not limited to ROM, RAM, SRAM, DRAM, CMOS, FLASH, DDR, SDRAM or some other memory technology. In some embodiments, the memory or parts thereof may be integrated with or internal to the processing device 302. The memory may store program instruction for execution by the processing device 302 (also see the description of FIG. 5A below), as well as temporary and permanent data for use by the processing device 302.

The short-range data communication interface 306 may be configured for Bluetooth communication, or any other radio-based short-range wireless data communication such as, for instance, Bluetooth Low Energy, RFID, WLAN, WiFi, mesh communication or LTE Direct, without limitation, or any non-radio-based short-range wireless data communication such as, for instance, magnetic communication (such as NFC), (ultra)sound communication, or optical communication (such as IrDA) without limitation. In some embodiments, the short-range data communication interface 306 comprises equipment and functionality for presenting or scanning a QR code.

The wide area network communication interface 308 may be configured for wide area network communication compliant with, for instance, one or more of W-CDMA, GSM, UTRAN, HSPA, LTE, LTE Advanced or 5G, and TCP/IP, and/or WLAN (WiFi), without limitation.

The user interface 310 may comprise an input device and a presentation device, as is generally known per se. In some embodiments, the input device and the presentation device are constituted by one common physical device, such as for instance a touch screen (touch-sensitive display screen), implemented in for instance resistive touch technology, surface capacitive technology, projected capacitive technology, surface acoustic wave technology or infrared technology.

The communication device 300 may further comprise a trusted execution environment TEE or alternatively a secure element, i.e. a tamper-resistant virtual or hardware-based platform. In the former case, the secure element may have its own CPU and protected memory. In the latter case, the trusted execution environment TEE may be implemented in software and may reside in the local storage or even the memory 304. The trusted execution environment TEE or secure element is capable of securely hosting applications and storing confidential and cryptographic data and therefore provides a trusted environment for execution of such applications, a.k.a. secure runtime. Advantageously, some of the data and functionality in embodiments of the invention may be stored in and performed by the trusted execution environment TEE (or secure element), as will be clear from other sections of this document. This is, for instance, so for the balance of the offline digital wallet DCWO and the private cryptographic key dcwallet_wallet_offline_priv_key as referred to above for the embodiment in FIG. 2C. The corresponding certified public cryptographic key is included in a digital certificate dcwallet_wallet_offline_cert which, too, may be stored in the TEE (or secure element) as seen in FIG. 3, or alternatively stored elsewhere.

The communication device 300 may hence be configured to perform the functionality of the payer communication device PD1 as defined in and described above for the system 100, method 600 and any or all of its embodiments. The payer communication device PD1 may thus be implemented by the communication device 300 in the form of, for instance, a mobile communication device, a mobile phone, a smart phone, a tablet computer, a personal digital assistant, a portable computer, smart glasses, a smart wearable, a smart watch, a smart bracelet, a smart card or a smart chip.

FIG. 4 illustrates a communication device 400 which may implement a payee communication device, like the aforementioned PD2, suitable for use in the digital payment system 100 and computerized method 600. To this end, the communication device 400 comprises a processing device 402, local storage including a memory 404, a short-range data communication interface 406, a wide area network communication interface 408 and a user interface 410.

The processing device 402 acts as a controller of the communication device 400 and may be implemented in much the same way as the processing device 302 referred to above. The memory 404 may be implemented in much the same way as the memory 404 referred to above and may store program instruction for execution by the processing device 402 (also see the description of FIG. 5A below), as well as temporary and permanent data for use by the processing device 402.

The short-range data communication interface 406 and the wide area network communication interface 408 may be implemented in much the same way as the short-range data communication interface 306 and the wide area network communication interface 308 referred to above. The same may apply to the user interface 410 with respect to the user interface 310.

The communication device 400 may hence be configured to perform the functionality of the payee communication device PD2 as defined in and described above for the system 100, method 600 and any or all of its embodiments. The payee communication device PD2 may thus be implemented by the communication device 400 in the form of, for instance, a mobile communication device, a mobile phone, a smart phone, a tablet computer, a personal digital assistant, a portable computer, smart glasses, a smart watch, a smart card, a smart bracelet, a smart wearable, a payment terminal, a service terminal, a point-of-sales terminal, a checkout counter, a delivery pickup point, a vending machine, a ticket machine, a dispensing machine, or an access control system.

FIG. 5A is a schematic illustration of a computer-readable medium 500 in one exemplary embodiment, capable of storing a computer program product 510. The computer-readable medium 500 in the disclosed embodiment is a portable memory device, such as a Universal Serial Bus (USB) stick. The computer-readable medium 500 may however be embodied in various other ways instead, as is well-known per se to the skilled person. The portable memory device 500 comprises a housing 530 having an interface, such as a connector 540, and a memory chip 520. In the disclosed embodiment, the memory chip 520 is a flash memory, i.e. a non-volatile data storage that can be electrically erased and re-programmed. The memory chip 520 stores the computer program product 510 which is programmed with computer program code (instructions) that when loaded into a processing device, such as a CPU, will perform any of the functionalities listed in the next paragraph. The processing device may, for instance, be the aforementioned processing device 302 or 402. The portable memory device 500 is arranged to be connected to and read by a reading device for loading the instructions into the processing device. It should be noted that a computer-readable medium can also be other media such as compact discs, digital video discs, hard drives or other memory technologies commonly used. The computer program code (instructions) can also be downloaded from the computer-readable medium via a wireless interface to be loaded into the processing device.

In one embodiment, therefore, the computer program product 510 comprises computer code for performing the functionality of the payer communication device PD1 in the system 100 or method 600 as described herein when the computer program code is executed by the processing device. In another embodiment, the computer program product 510 comprises computer code for performing the functionality of the payee communication device PD2 in the system 100 or method 600 as described herein when the computer program code is executed by the processing device. In still other embodiments, the computer program product 510 comprises computer code for performing the functionality of the digital wallet server function DCWS in the system 100 or method 600 as described herein when the computer program code is executed by the processing device.

The flowchart diagrams in FIGS. 7-11 will now be described in some detail.

FIG. 7 illustrates top-up activities, as previously mentioned. Three entities are shown in this drawing: the first financial institution PB1 (a.k.a. the payer bank), the computerized digital wallet server function DCWS and the payer communication device PD1 used by the payer P1. The payer account PA1 associated with the payer P1 is maintained by the payer bank PB1 in a list of customers 702. The computerized digital wallet server function DCWS maintains the digital wallet DCW of the payer P1 in a list of users 704. The payer communication device PD1 has access to the alias of the payer, PayerAiias, and a link by which the digital wallet DCW of the payer P1 can be accessed at the digital wallet server function DCWS. This can be seen at 706. In this embodiment, the payer communication device PD1 is enabled also for offline digital payments (cf. FIG. 2C), and consequently the payer communication device PD1 has the aforementioned offline digital wallet DCWO of the payer P1 in local storage. This can be seen at 707. Note that the offline digital wallet DCWO is referred to as dc_wallet_offline in FIG. 7.

A topup procedure for the payer account PA1 is shown at 710 and is requested by the payer communication device PD1 through the digital wallet server function DCWS, as seen at 712-714. In response, funds may be transferred to the payer account PA1 by for instance an internal or external bank transfer. As a result, the balance of the payer account PA1 is created or increased at 716 (cf. 553 in FIG. 5B), with confirmations being given to the digital wallet server function DCWS and the payer communication device PD1 at 718 and 720.

A topup procedure for the digital wallet DCW is shown at 730. In the disclosed embodiment, topup is requested by the payer communication device PD1 through the digital wallet server function DCWS, as seen at 732-734. Provided that the balance of the payer account PA1 covers the requested topup amount, a reservation of the requested topup amount is made in the payer account PA1 (cf. 554 in FIG. 5B) in step 736. A response is given to the digital wallet server function DCWS at 738, wherein the balance of the digital wallet DCW is increased accordingly in step 740 (cf. 563 in FIG. 5B). A confirmation is given to the payer communication device PD1 at 742.

This corresponds to step 1 in FIGS. 2A, 2B and 2D, and step 1a in FIG. 2C.

As a beneficial alternative to the above, topup of the digital wallet DCW may be handled automatically. This is particularly so when the computerized digital wallet server function DCWS is hosted by the first financial institution PB1. The computerized core banking system of the first financial institution PB1 may be configured to detect that the digital wallet DCW is in need of a topup, for instance when the balance drops below a threshold, and automatically perform a topup by reserving an appropriate topup amount in the payer account PA1 and increasing the balance of the digital wallet DCW accordingly. Such an automatic topup may even be seamless to the payer P1; he or she may be presented with a total spending balance without having to care about how it is disposed between the payer account PA1 and the digital wallet DCW.

A topup procedure for the offline digital wallet DCWO (dc_wallet_offline) is shown at 750 and is requested by the payer communication device PD1 at the digital wallet server function DCWS, as seen at 752. Provided that the balance of the digital wallet DCW of the payer P1 covers the requested topup amount, a reservation of the requested topup amount is made in the digital wallet DCW (cf 565 in FIG. 5B) in step 754. A response is given by the digital wallet server function DCWS to the payer communication device PD1 at 756, wherein the balance of the offline digital wallet DCWO is increased accordingly in step 758 (cf. 573 in FIG. 5B). This corresponds to step 1b in FIG. 2C.

The topup requests by the payer communication device PD1 at 712, 732 and 752, respectively, and their respective responses 720, 742 and 756, may be made over a secure communication tunnel (https or token-based, cf. PD Credentials in FIG. 7) by way of wide-area network communication (e.g. TCP/IP). Alternatively, the communication may take place pursuant to SS7 telephony signaling protocols as, for instance, SMS or USSD data over a cellular telecommunications network; this may involve digital signing by means of a private cryptographic key in a trusted application run on the payer communication device PD1. Yet other communication alternatives can be perceived.

FIG. 8 illustrates payment activities as implementation examples of the embodiments described and referred to above with reference to FIGS. 2A-2D. In addition to the entities shown in FIG. 7, FIG. 8 also shows the computerized payment switch functionality PS (a.k.a. payment switch), the payee communication device PD2 and the second financial institution PB2 (a.k.a. payee bank). Elements 802-807 correspond to elements 702-707 in FIG. 7. The payee communication device PD2 has access to the alias of the payee, PayeeAlias, as seen at 808. Moreover, in the disclosed embodiment the payee communication device PD2 has access to functionality 809 (dc_verifier) for offline_payment verification purposes. This will be explained later with reference to FIG. 10.

The payment switch PS maintains the aforementioned maintains cross-reference data 810 (mapping) that links payer aliases and payee aliases of payers and payees (including those of the payer P1 and payee P2) to the payer accounts and payee accounts at the first and second financial institutions PB1, PB2 (including the payer account PA1 and payee account PA2). As such, the payee account PA2 associated with the payee P2 is maintained by the payee bank PB2 in a list of customers 812.

The digital payment sequence is shown at 820. It may typically be triggered by user input from the payer P1 to the payer communication device PD1, or by communication 822 from the payee communication device PD2. At 824, the payer communication device PD1 checks whether it is online in the sense that it can access the digital wallet server function DCWS by wide area network communication. If it can, branch 825 is pursued, if not, branch 826 is pursued. Starting with the latter outcome, this will involve an offline digital payment 830, the particulars of which will be given below with reference to FIG. 10. Offline digital payments have also been described above with reference to FIG. 2C.

For the 825 outcome, i.e. when the payer communication device PD1 is online, a payment request is generated and sent by the payer communication device PD1 to the digital wallet server function DCWS. This corresponds to step 2 in FIG. 2A. At 832, the payer communication device PD1 then checks whether the payer P1 as represented by the PayerAlias has a digital wallet, i.e. the digital wallet DCW in the present case, and whether the balance of it covers the requested payment amount, Amount. In case there is no sufficient coverage, a request for immediate settlement is made to the payer bank PB1 at 834. This corresponds to steps 3 and 4a in FIG. 2A.

On the other hand, if there is indeed sufficient coverage for the requested payment amount in the digital wallet DCW, the payer communication device PD1 proceeds in steps 836 and 838 to register and store the transaction data. This corresponds to what has been described above for steps 3 and 4 in FIG. 2B. The balance of the digital wallet DCW is reduced by the requested payment amount, Amount. Then follows payment confirmation at 840, the details of which will be described with reference to FIG. 11.

For alternative embodiments that support split payments as discussed above, step 832 may be modified to handle this.

The payment request by the payer communication device PD1 at 825 (and the corresponding response in FIG. 11) may be made over a secure communication tunnel (https or token-based, cf. PD Credentials) by way of wide-area network communication (e.g. TCP/IP). Alternatively, the communication may take place pursuant to SS7 telephony signaling protocols as, for instance, SMS or USSD data over a cellular telecommunications network; this may involve digital signing by means of a private cryptographic key in a trusted application run on the payer communication device PD1. Yet other communication alternatives can be perceived.

FIG. 9 illustrates settlement activities in embodiments of the present invention. The entities are the same as in FIG. 8. Elements 902-912 thus correspond to elements 802-812 in FIG. 8. Block 920 is a stage for settling offline digital payments, i.e. payments that have been performed in box 830 in FIG. 8 and that will be described in detail below with reference to FIG. 10. In block 920, the payee communication device PD2 processes all stored offline digital payments in step 924 and sends a request 926 to the payment switch PS. By using a unique paymentID for each stored offline_payment, the payment switch PS checks that the particular transaction has not been settled before (to prevent double debit), and in response sends a request 930 to the digital wallet server function DCWS. In step 932, the digital wallet server function DCWS releases the payment amount Amount from the reservation of funds in the digital wallet DCW, reduces the balance of the digital wallet DCW, and sends a settlement request 934 to the payer bank PB1.

To settle an online digital payment, the digital wallet server function DCWS processes all stored online digital payments in step 940 and sends a request 942 to the payer bank PB1.

Upon receipt of a request 934 (offline) or 942 (online), the payer bank PB1 checks that the payment amount of the digital payment to the settled is covered by the balance of the payer account PA1. In the extraordinary event that this condition is not satisfied, something has gone wrong and settlement must not be performed. Notification of the failure is made to the involved entities in steps 946, 948 and 950.

In the normal case 952 that the check is successful in step 944, the payer bank PB1 sends a settlement request 954 to the payment switch PS. In step 956 the payment switch PS executes settlement. This involves communication with the payer bank PB1 as well as the payee bank PB2. At the payee bank PB2, the balance of the payee account PA2 is increased by the payment amount in step 958, whereas at the payer bank PB1, the balance of the payer account PA1 is reduced by the same payment amount in step 960. In alternative embodiments, a small charge (e.g. transaction fee) for the digital payment may be debited to one or both of the payer account PA1 or payee account PA2.

Then, in step 962, when the settled digital payment is an online digital payment, the payer bank PB1 releases the payment amount Amount from the reservation of funds in the payer account PA1 (i.e., the reservation 554 in FIG. 5B is reduced by the payment amount). The corresponding action is taken in step 964 when the settled digital payment is an offline digital payment.

Moreover, when the settled digital payment is an offline digital payment, the payer bank PB1 sends an offline digital payment settlement confirmation at step 966 to the digital wallet server function DCWS, and the confirmation is forwarded to the payment switch PS in step 968 and to the payee communication device PD2 in step 970. Correspondingly, when the settled digital payment is an online digital payment, the payer bank PB1 sends an online digital payment settlement confirmation at step 972 to the digital wallet server function DCWS, causing the digital payment to be marked as settled. Similarly, in the case when the digital payment was settled immediately (like in FIG. 2A), the payer bank PB1 sends a digital payment settlement confirmation at step 976 to the digital wallet server function DCWS.

FIG. 10 is a sequence and signal diagram illustrating offline_payment activities in embodiments of the present invention. Unlike the other kinds of digital payments presented in this document (i.e., online digital payments and digital payments for immediate settlement), the making of offline digital payments involves only the payer communication device PD1 and the payee communication device PD2, being proximate to each other and hence communicating by short-range data communication. Accordingly, only these two devices are shown in FIG. 10.

It is recalled that the payer communication device PD1 has access to the alias of the payer P1, PayerAlias. This can be seen at 1002 in FIG. 10. Correspondingly, the payee communication device PD2 has access to the alias of the payee P2, PayeeAlias. It is also recalled that the payer communication device PD1 keeps the offline digital wallet DCWO (referred to as dc_wallet_offline in FIG. 10) of the payer P1 in local storage. This can be seen at 1003.

As can be further seen at 1003, a private cryptographic key dcwallet_wallet_offline_priv_key is kept secure by the payer communication device, and there is also a certified public cryptographic key dcwallet_wallet_offline_cert that corresponds to the private cryptographic key. (More specifically, in practical embodiments, dcwallet_wallet_offline_cert may be a certified digital certificate that includes the public cryptographic key. For reasons of simplicity, the public cryptographic key is referred to as dcwallet_wallet_offline_cert in this document.)

The making of an offline digital payment is illustrated in box 1012. First, the payer communication device PD1 checks that the balance of the offline digital wallet DCWO covers the payment amount (Amount). Should this not be the case, the execution will abort. When the outcome of the check is successful, the balance of the offline digital wallet DCWO is reduced by the payment amount.

Then, transaction data TBS (“to be signed”) is generated which includes PayerAlias, PayeeAlias and Amount, as well as other data such as a ServiceID, transaction_offlineID, timestamp and dcwallet_wallet_offline_cert. Cf. step 2 in FIG. 2C. The transaction data TBS is signed using dcwallet_wallet_offline_priv_key, resulting in a signature S. Cf. step 3 in FIG. 2C. Signed transaction data offline_payment is thus made up of the transaction data TBS and the signature S. Optionally, the signed transaction data offline_payment may be stored (buffered) locally in the payer communication device PD1 for later uploading to the payment switch PS to cause settlement by wide-area network communication when the payer communication device PD1 has gained such communication ability.

The payer communication device PD1 then communicates the signed transaction data offline_payment to the payee communication device PD2 by short-range data communication in step 1014. Cf step 4 in FIG. 2C. In response, the payee communication device PD2 performs the functionality shown in box 1016 in FIG. 10.

As has been briefly mentioned before in conjunction with element 809 in FIG. 8, the payee communication device PD2 has access to dc_verifier functionality for offline_payment verification purposes. The dc_verifier functionality may be provided for local execution in the payee communication device PD2 as can be seen at 1005. Alternatively, the dc_verifier functionality may be accessed by requesting verification from another entity in (or possibly external to) the digital payment system. In such embodiments, the transaction data TBS may include a specification of a verification resource, such as a uniform resource locator (URL), from which the payee communication device PD2 may request such verification.

In box 1016 in FIG. 10, the payee communication device PD2 invokes the dc_verifer functionality to verify the received signed transaction data offline-payment. This involves the following.

First, the public cryptographic key dcwallet_wallet_offline_cert, that was included in the transaction data TBS, is verified (or validated) by means of a trusted digital certificate ca_root_cert that the payee communication device PD2 has been provided with (as seen at 1005 in FIG. 10). It is recalled that dcwallet_wallet_offline_cert corresponds to the private cryptographic key dcwallet_wallet_offline_priv_key by which the transaction data TBS was signed in box 1012 by the payer communication device PD1. Cf. step 5 in FIG. 2C. The trusted digital certificate ca_root_cert may be a root digital certificate issued by a certificate authority being independent from the entities of the digital payment system.

Once the public cryptographic key dcwallet_wallet_offline_cert has been successfully verified, it is used by the dc_verifier functionality to verify the signature S of the signed transaction data offline_payment. Upon success, the signed transaction data offline_payment is stored (buffered) locally in the payee communication device PD2 (cf. step 6 in FIG. 2C) for subsequent uploading to the payment switch PS to initiate settlement of the offline digital payment, as has been described with reference to steps 924 and 926 in FIG. 9. Cf step 8a in FIG. 2C. Note that such uploading to the payment switch PS is not part of box 1016.

Provided that the verification in box 1016 was successful, the payee communication device PD2 can trust the received offline digital payment and may thus provide a goods or perform a service associated with the offline digital payment, or enable the payee P2 to do so. This can be seen at 1018 in FIG. 10. It is recalled that this may beneficially take place before settlement of the offline digital payment.

FIG. 11 illustrates payment confirmation activities in embodiments of the present invention. It is recalled that payment confirmation follows once the payment activities described above with reference to FIG. 8 have been performed. A payment confirmation step 1110 is performed by the digital wallet server function DCWS. This involves generating payment confirmation data TD which includes PayerAlias, PayeeAlias and Amount, as well as other data such as a Status, ServiceID, transactionID and timestamp Cf. step 5 in FIGS. 2A, 2B and 2D.

Optionally, as seen at 1103, the digital wallet server function DCWS may have a private cryptographic key dcwallet_wallet priv_key which is kept secure, and it may also have a certified public cryptographic key dcwallet_wallet_cert that corresponds to the private cryptographic key. (More specifically, in practical embodiments, dcwallet_wallet_cert may be a certified digital certificate that includes the public cryptographic key. For reasons of simplicity, the public cryptographic key is referred to as dcwallet_wallet_cert in this document.) In such embodiments, the payment confirmation data TD may be generated to include dcwallet_wallet_cert. The digital wallet server function DCWS may sign the generated payment confirmation data TD using the private cryptographic key dcwallet_wallet priv_key, resulting in a signature S.

Box 1112 continues to generate a payment confirmation from the generated payment confirmation data TD and, optionally, the signature S.

The payment confirmation can be communicated by the digital wallet server function DCWS in different ways. As seen at 1114, the payment confirmation is communicated to the payer communication device PD1, and the payment confirmation may be forwarded to the payee communication device PD2 in step 1122. Alternatively, the payment confirmation can be communicated by the digital wallet server function DCWS directly to the payee communication device PD2, as seen in step 1132.

A further alternative is for the digital wallet server function DCWS to communicate the payment confirmation to the payment switch PS in step 1142. Advantageously, the payment switch PS may have payment confirmation verification functionality dc_verifier_ps (see 1109), which may be invoked in a step 1144 to verify (or validate) the payment confirmation. The verification may, first, involve verifying dcwallet_wallet_cert as included in the confirmation data TD of the received payment confirmation by means of a certified digital certificate ca_root_cert (cf. the discussion for FIG. 10 above). Upon success, the signature S as included in the received payment confirmation may be verified by means of dcwallet_wallet_cert. Upon success, a confirmation may be sent by the payment switch PS to the payee communication device PD2 in a step 1146.

In embodiments where the payee communication device PD2 receives the payment confirmation from the payer communication device PD1 (cf. step 1122) or directly from the digital wallet server function DCWS (cf. step 1132), the payee communication device PD2 may verify the received payment confirmation in a step 1148 by invoking payment confirmation verification functionality dc_verifer (see 1107) that works in the same way as the payment confirmation verification functionality dc_verifier_ps in step 1144. Similar to the discussion above for FIG. 10, the payment confirmation verification functionalities dc_verifier_ps and dc_verifier may be provided for local execution in the payment switch PS and the payee communication device PD2, respectively. Alternatively, verification may be requested from another entity in (or possibly external to) the digital payment system by invoking a specification of a verification resource, such as a uniform resource locator, included in the payment confirmation data TD.

The cloud computing resources as referred to in this document may for instance be implemented as one or more physical server computers or computer systems, or one or more distributed networks of computing resources.

The digital certificates referred to in this document may, for instance, be DER-encoded X.509-based certificates which comprise public cryptographic keys for the respective entities of the digital payment system 100, as described above.

When reference in this document is being made to a private cryptographic key which is associated with a particular digital certificate, this includes a case where the particular digital certificate comprises a public cryptographic key, and where the private (secure) cryptographic key and the public cryptographic key together constitute a cryptographic key pair as is generally known for asymmetric data encryption and decryption.

When reference in this document is being made to “settlement”, it may also be considered to refer, implicitly if not explicitly, to “clearing” as a preparatory or preceding step of the actual settlement. Hence, the locution “initiating settlement of the digital payment” shall be construed to include all of the following alternatives: initiating actual settlement, initiating clearing as an integrated part of settlement, and initiating clearing which in turn invokes, causes or is otherwise followed by settlement”.

In the description above, the first financial institution PB1 has been exemplified as a bank. The same goes for the second financial institution PB2. Banking is presently considered to be an area in which the present invention gives particular advantages and provides various technical improvements which have been identified above. For instance, as will be understood from the discussions in this document, the computerized digital wallet server function DCWS may advantageously take the form of a complementary or additional layer of computerized core banking resources of the first financial institution PB1 or, differently put, be hosted by the first financial institution PB1. Having said this, the present invention may be applicable in other areas too. It may, for instance, be of value to apply the present invention in a use case where (at least) the first financial institution PB1 is a cellular (mobile) communications network operator that offers mobile money services like, for instance, M-Pesa.

1-32. (canceled)

33. A computerized method of performing a digital payment by a payer to a payee, comprising
maintaining, at a financial institution, a reservation of funds in a payer account, the payer account being associated with the payer;
maintaining, by a computerized digital wallet server function, a digital wallet for the payer, the digital wallet having a balance corresponding to the reservation of funds in the payer account;
making, by a payer communication device usable by the payer, a payment request for the digital payment at the digital wallet server function;
by the digital wallet server function:
registering transaction data for the digital payment, the transaction data comprising an alias of the payer, an alias of the payee, and a representation of a payment amount, the payment amount being deducted from the balance of the digital wallet;
causing a digital notification of the digital payment to a payee communication device usable by the payee;
storing the transaction data for later settlement; and
subsequently initiating settlement of the digital payment based on the stored transaction data to cause release of the payment amount from the reservation of funds, deduction of funds from a balance of the payer account and addition of funds to a payee account associated with the payee, wherein the deduction and addition of funds correspond to the payment amount.

34. The method as defined in claim 33,
wherein the digital notification of the digital payment to the payee communication device serves as an instant notification to the payee that the payment amount has been logically transferred from the payer, even though the digital payment has not yet been settled, and
wherein upon being instantly notified by the digital notification of the digital payment, the payee communication device provides a goods or performs a service associated with the digital payment, or enables the payee to do so.

35. The method as defined in claim 33, wherein:
the digital wallet server function initiates settlement of the digital payment by communicating the stored transaction data to a computerized payment switch functionality;
the payment switch functionality maintains cross-reference data that links payer aliases and payee aliases of payers and payees to user accounts at financial institutions or payment service providers; and
the payment switch functionality uses the communicated transaction data and the cross-reference data to cause settlement of the digital payment.

36. The method as defined in claim 33, wherein:
the payer communication device is enabled for a plurality of payment services, each payment service having a respective payment service provider;
the payer communication device includes in the payment request an indication of a selected payment service among said plurality of payment services;
the digital wallet server function includes the indication of the selected payment service in the transaction data for the digital payment; and
the payment switch function uses the indication of the selected payment service to communicate with the payment service provider of the selected payment service.

37. The method as defined in claim 33, further involving:
maintaining, by the payer communication device, an offline digital wallet for the payer, the offline digital wallet having a balance corresponding to a reservation of funds in the digital wallet maintained for the payer by the computerized digital wallet server function; and performing an offline digital payment by:
the payer communication device:
generating transaction data for an offline digital payment, the transaction data comprising an alias of the payer, an alias of the payee, and a representation of a payment amount, the payment amount being deducted from the balance of the offline digital wallet;
signing the transaction data for the offline digital payment; and
communicating the signed transaction data to the payee communication device; and
the payee communication device:
receiving the signed transaction data from the payer communication device;
verifying the signed transaction data; and, upon successful verification:
storing the signed transaction data; and
initiating settlement of the offline digital payment based on the stored signed transaction data to cause release of the payment amount from the reservation of funds in the digital wallet, deduction of funds from the balance of the payer account and addition of funds to the payee account, wherein the deduction and addition of funds correspond to the payment amount.

38. The method as defined in claim 37, wherein upon successful verification of the signed transaction data, the payee communication device provides a goods or performs a service associated with the digital payment, or enables the payee to do so.

39. The method as defined in claim 37, wherein
the payer communication device signs the transaction data for the offline digital payment by means of a private cryptographic key kept secure by the payer communication device; and
the signed transaction data is verified by means of a certified public cryptographic key corresponding to the private cryptographic key.

40. The method as defined in claim 37, further involving:
transferring some or all of the balance of the offline digital wallet from the payer communication device to another device by short-range data communication, wherein said another device subsequently acts as a payment sending device using the transferred balance to make an offline digital payment in a payment amount covered by the transferred balance to a payment receiving device by performing the steps of the payer communication device; and
wherein the payment receiving device receives and handles the offline digital payment by performing the steps of the payee communication device.

41. The method as defined in claim 33, further involving the digital wallet server function:
initially determining that the payment amount of the payment request for the digital payment exceeds the balance of the digital wallet for the payer; and
splitting the digital payment into two parts,
a first part of the digital payment being performed by the steps recited in claim 33 in a first payment amount which does not exceed the balance of the digital wallet for the payer, and
a second part of the digital payment being performed by initiating immediate settlement of the digital payment based on the alias of the payer, the alias of the payee and a representation of a second payment amount to cause deduction of funds from the balance of the payer account and addition of funds to the payee account, wherein the deduction and addition of funds correspond to the second payment amount, and wherein the second payment amount is the difference between the payment amount and the first payment amount.

42. The method as defined in claim 33, wherein the computerized digital wallet server function takes the form of a complementary or additional layer of computerized core banking resources of the first financial institution.

43. The method as defined in claim 33, wherein the computerized digital wallet server function is hosted by the first financial institution.

44. The method as defined in claim 33, the first financial institution having a computerized core banking system, wherein the method further involves:
the computerized core banking system detecting that the digital wallet is in need of a topup; and
in response performing a topup by reserving an appropriate topup amount in the payer account and increasing the balance of the digital wallet accordingly.

45. A digital payment system comprising:
a computerized digital wallet server function; and
a payer communication device usable by a payer;
wherein the payer communication device is configured for making a payment request for a digital payment at the digital wallet server function; and
wherein the computerized digital wallet server function is configured for:
maintaining a digital wallet for the payer, the digital wallet having a balance corresponding to a reservation of funds in a payer account maintained at a financial institution, the payer account being associated with the payer;
registering transaction data for the digital payment, the transaction data comprising an alias of the payer, an alias of a payee, and a representation of a payment amount, the payment amount being deducted from the balance of the digital wallet;
causing a digital notification of the digital payment to a payee communication device usable by the payee;
storing the transaction data for later settlement; and
subsequently initiating settlement of the digital payment based on the stored transaction data to cause release of the payment amount from the reservation of funds, deduction of funds from a balance of the payer account and addition of funds to a payee account associated with the payee, wherein the deduction and addition of funds correspond to the payment amount.

46. A server-based computing resource configured to perform the functionality of the computerized digital wallet server function in the method as defined by claim 33.

47. A communication device configured to perform the functionality of the payer communication device in the method as defined by claim 33.

48. A communication device configured to perform the functionality of the payee communication device in the method as defined by claim 33.

49. A non-volatile computer readable medium having stored thereon a computer program comprising computer program code for performing the functionality of the computerized digital wallet server function in the method as defined by claim 33 when the computer program code is executed by a processing device.

50. A non-volatile computer readable medium having stored thereon a computer program comprising computer program code for performing the functionality of the payer communication device in the method as defined by claim 33 when the computer program code is executed by a processing device.

51. A non-volatile computer readable medium having stored thereon a computer program comprising computer program code for performing the functionality of the payee communication device in the method as defined by claim 33 when the computer program code is executed by a processing device.

52. A multi-layered digital payment system architecture comprising:
a core banking system layer that pertains to a financial institution and includes computerized core banking resources, the computerized core banking resources maintaining an account balance for an account owned or controlled by a bank client; and
a first additional layer allowing the bank client to make online digital payments from a digital wallet having a balance which has been reserved from the account balance in the core banking system layer.

53. The multi-layered digital payment system architecture as defined in claim 52, further comprising:
a second additional layer allowing the bank client to make offline digital payments from an offline digital wallet having a balance which has been reserved from the balance of the digital wallet in the first additional layer.

54. The multi-layered digital payment system architecture as defined in claim 53, the offline digital wallet of the second additional layer being hosted by a first communication device operated by the bank client, the architecture further comprising:
a third additional layer allowing the bank client to transfer at least a part of the balance of the offline digital wallet to a second communication device, wherein a user of the second communication device may use a balance of the second communication device to make offline digital payments.
